(19) United States
(12) Patent Application Publication
(10) Pub. No.: US 2021/0221463 A1
(43) Pub. Date: Jul. 22, 2021

(54) OPTICAL ROTATING WHEEL AND SELF-BALANCING VEHICLE

(71) Applicant: E-LINK TECHNOLOGY CO.,LTD, SHENZHEN (CN)

(72) Inventors: Minyi CHEN, SHENZHEN (CN); Pingzhi LI, SHENZHEN (CN); Xihui JIANG, SHENZHEN (CN); Yufeng CHEN, SHENZHEN (CN)

(21) Appl. No.: 16/845,100

(22) Filed: Apr. 10, 2020

(30) Foreign Application Priority Data
Jan. 17, 2020 (CN) 202020113483.7

(51) Int. Cl. B62K 11/00; B60L 15/00; G07C 5/00; G05B 19/048; G05D 1/00

(52) U.S. Cl. CPC B62K 11/007; B60L 15/00; G05D 1/0027; G05B 19/048; G07C 5/00

(57) ABSTRACT

Disclosed are an optical rotating wheel and a self-balancing vehicle. The optical rotating wheel of the present application includes a stationary component, a moving component, a light source connected with the stationary component, and a laser plate connected with the moving component, in which the stationary component is fixedly connected with the vehicle body and relatively static with respect to the vehicle body, while the moving component is rotationally connected with the stationary component. Moreover, the laser plate is provided with a laser dot which displays a preset pattern under an illumination of the light source, and when the moving component rotates, the preset pattern rotates around the light source. In such a way, a dynamic optical pattern is obtained in the optical rotating wheel and self-balancing vehicle.

### TECHNICAL FIELD

The present disclosure relates generally to a technical field of sport equipment, and more particularly, to an optical rotating wheel and a self-balancing vehicle.

### BACKGROUND

Nowadays, self-balancing vehicles, which are used for mobility or entertainment, are more and more popular among young people. The main reason for why so many young people like such self-balancing vehicle lies in that its driving requires no two-handed operation, but just two feet, so the control for the movement of the self-balancing vehicle is very easy, which brings convenience and gee-whiz feelings to young people. However, as more and more manufacturers take part in, the competition of the self-balancing vehicle is getting more and more intense. The simple operation of the self-balancing vehicle cannot capture the attention of many young people any longer. How to improve the attractiveness of the self-balancing vehicle is currently demanded by many manufacturers and young people.

### SUMMARY

In the present disclosure, an optical rotating wheel and a self-balancing vehicle are provided, aiming at the shortcomings of the above existing technologies.

In one aspect, an optical rotating wheel is provided, which including a stationary component, a moving component, a light source connected with the stationary component, and a laser plate connected with the moving component; wherein the stationary component includes a motor shaft fixedly connected with a vehicle body, and a stator fixedly connected with the motor shaft; wherein the moving component includes a rotor rotationally connected with the stator, and a wheel body fixedly connected with the rotor; wherein the laser plate is provided, with a laser dot which displays a preset pattern under an illumination of the light source, and when the moving component rotates, the preset pattern rotates around the light source.

Optionally, the light source includes a plurality of light-emitting points surrounding the motor shaft, and the laser dot displays a plurality of preset patterns under the illumination of the plurality of light-emitting points; wherein when the moving component rotates, the plurality of preset patterns rotate respectively around their respective light-emitting points. In a preferable embodiment, the light source includes a circuit board and a plurality of LED lamp beads attached on the circuit board. In a more preferable embodiment, the circuit board is connected to the motor shaft and is spaced from the stator by an interval.

Optionally, the optical rotating wheel further includes a first cover connected with the wheel body, the laser plate is connected with a first side of the first cover facing the light source, and a first area of the first cover corresponding to the light source is transparent or hollow out. In a preferable embodiment, the first area of the first cover corresponding to the light source is hollow out, and the laser plate and the first cover are detachably connected with each other.

Optionally, the optical rotating wheel further includes a first cover and a second cover successively connected with the wheel body, wherein the laser plate is arranged between the first cover and the second cover, wherein a first area of the first cover corresponding to the light source is transparent or hollow out, and a first area of the second cover corresponding to the light source is transparent or hollow out. In a preferable embodiment, the first, area of the second cover corresponding to the light source is hollow out; the laser plate and the first cover, or the laser plate and the second cover are detachably connected with each other.

Optionally, the optical rotating wheel further includes a heat insulation pad whose opposite sides are respectively connected with the circuit board and the stator.

In another aspect, a self-balancing vehicle is provided, which including a vehicle body and the optical rotating wheel discussed above, wherein the optical rotating wheel is connected with the vehicle body to drive the vehicle body to move.

The optical rotating wheel of the present application includes a stationary component, a moving component, a light source connected with the stationary component, and a laser plate connected with the moving component, in which the stationary component is fixedly connected, with the vehicle body and relatively immovable with respect to the vehicle body, while the moving component is rotationally connected with the stationary component. Moreover, the laser plate is provided with a laser dot which displays a preset pattern under an illumination of the light source, and when the moving component rotates, the preset pattern rotates around the light source. In such a way, a dynamic optical pattern is obtained.

Specifically, the stationary component includes a motor shaft fixedly connected with a vehicle body, and a stator fixedly connected with the motor shaft; wherein the moving component includes a rotor rotationally connected with the stator, and a wheel body fixedly connected with the rotor. Among them, the stator and the rotor form an external rotor motor, and the wheel body is brought to rotate by the rotor. The light source is connected with the stationary component, while the laser plate is connected with the moving component. Moreover, the laser plate is provided with a laser dot which displays a preset pattern under an illumination of the light source. The layout, angle and depth of the laser dot will affect the type of preset patterns. In this disclosure, the preset pattern of five-pointed star is taken as an example for explanation. Of course, the preset pattern can also be triangle, heart-shaped, smiling face-shaped, etc. When the moving component rotates, the preset pattern rotates around the light source.

### BRIEF DESCRIPTION OF THE DRAWINGS

In order to explain the technical solutions in the embodiments of the present disclosure more clearly, the drawings used in the description of the embodiments are briefly introduced below. Obviously, the drawings in, the following description are just some implementations of the present disclosure. For example, for one skilled in the art, other drawings can be obtained based on these drawings without any inventive work.

FIG. 1 is a structural diagram of a self-balancing vehicle according to an embodiment of the present application.

FIG. 2 is an exploded structural diagram of an optical rotating wheel according to an embodiment of the present application.

FIG. 3 is a lateral structural diagram of an optical rotating wheel according to an embodiment of the present application.

### DETAILED DESCRIPTION OF THE PREFERRED EMBODIMENT

The technical solutions in the embodiments of the present application will be clearly and completely described below with reference to the drawings in the embodiments of the present application. It can be understood that the specific embodiments described herein are only used to explain, the present application, but not to limit the present application. It should also be noted that, for the convenience of description, only some components related to the present application instead of the entire structure are shown in the drawings. Based on the embodiments of the present application, all other embodiments obtained by one skilled in the art without any inventive work shall fall within the protection scope of the present application.

Reference to “embodiment” herein means that a particular feature, structure, or characteristic described in connection with the embodiment may be included in at least one embodiment of the present application. The appearances of this phrase in various places in the specification are not necessarily all referring to the same embodiment, nor are independent or alternative embodiments that are mutually exclusive with other embodiments. It is explicitly and implicitly understood by one skilled in the art that the embodiments described herein may be combined with other embodiments.

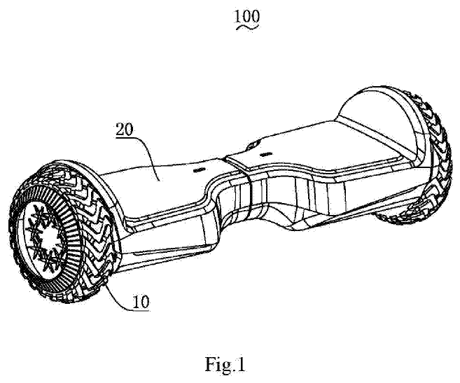

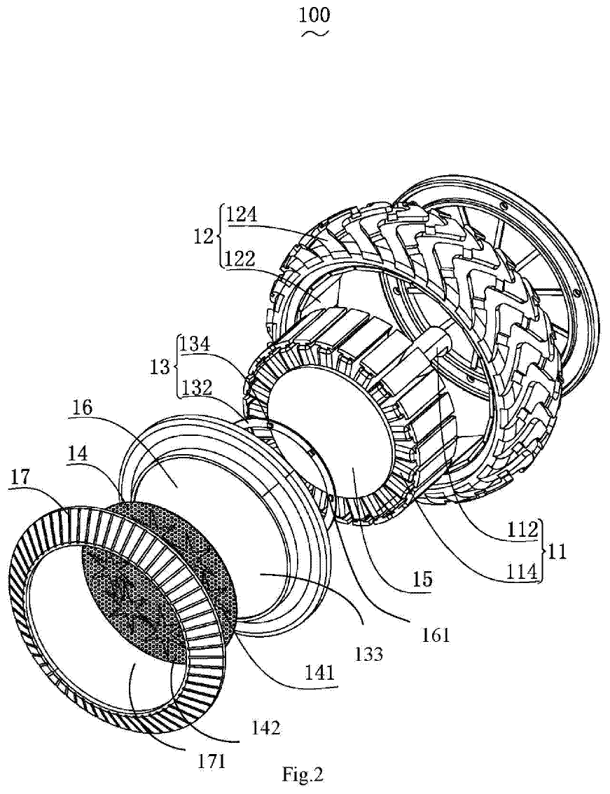

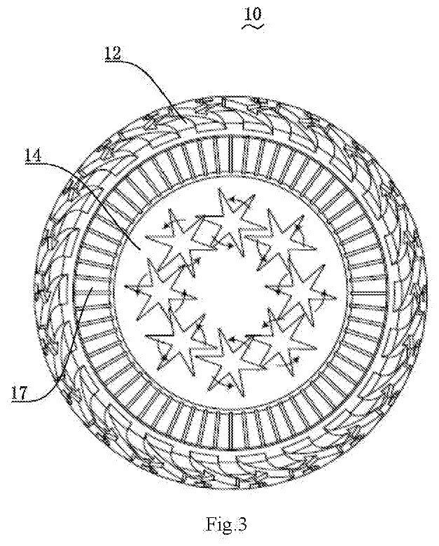

Now, refer to FIGS. 1-3, in which FIG. 1 is a structural diagram of the self-balancing vehicle 100 according to an embodiment of the present application, FIG. 2 is an exploded structural diagram of the optical rotating wheel 10 according to an embodiment of the present application, while FIG. 3 is a lateral structural diagram of the optical rotating wheel 10 according to an embodiment of the present application.

The self-balancing vehicle 100 of the present application includes a vehicle body 20 and an optical rotating wheel 10 connected to the vehicle body 20. The optical rotating wheel 10 is used to drive the vehicle body 20 to move forward. The number of the optical rotating wheel 10 may be one, two, three etc., and is not limited here.

The optical rotating wheel 10 includes a stationary component 11, a moving component 12, a light source 13 connected with the stationary component 11, and a laser plate 14 connected with the moving component 12. The stationary component 11 is fixedly connected with the vehicle body 20 and relatively immovable with respect to the vehicle body 20, while the moving component 12 is rotationally connected with the stationary component 11. Moreover, the laser plate 14 is provided with a laser dot which displays a preset pattern 141 under an illumination of the light source 13. When the moving component 12 rotates, the preset pattern 141 rotates around the light source 13. In such a way, a dynamic optical pattern is obtained.

Specifically, the stationary component 11 includes a motor shaft 112 fixedly connected with a vehicle body 20, and a stator 114 fixedly connected with the motor shaft 112. The moving component 12 includes a rotor 122 rotationally connected with the stator 114, and a wheel body 124 fixedly connected with the rotor 122. Among them, the stator 114 and the rotor 122 form an external rotor motor, and the wheel body 124 is brought to rotate by the rotor 122. The light source 13 is connected with the stationary component 11, while the laser plate 14 is connected with the moving component 12. Moreover, the laser plate 14 is provided with a laser dot which displays a preset pattern 141 under an illumination of the light source 13. The layout, angle and depth of the laser dot will affect the type of preset patterns. In this disclosure, the preset pattern 141 of five-pointed star is taken as an example for explanation. Of course, the preset pattern 141 can also be triangle, heart-shaped, smiling face-shaped, etc. When the moving component 12 rotates, the preset pattern 141 rotates around the light source 13, which means such rotation takes the light source 13 as the center.

The light emitted from the light source 13 passes through the laser plate 14 and presents a preset pattern 141. When the rotor 122 drives the wheel body 124 to rotate, the laser plate 14 will rotate along with it. When the light source 13 rotates relative to the laser plate 14, the pattern is rotated around the light source 13, so that the dynamic rotation effect of the pattern, is presented. Through this new type of application, the static pattern is converted into a rotating pattern, thereby achieving the rotating effect of the optical pattern at a low cost.

The light source 13 includes a plurality of light-emitting points 133 surrounding the motor shaft 112, and the laser dot 142 displays a plurality of preset patterns 141 under the illumination of the plurality of light-emitting points 133. When the moving component 12 rotates, the plurality of preset patterns 141 rotate respectively around their respective light-emitting point 133.

The light emitted from the light source 13 passes through the laser plate 14 and presents a preset pattern 141. When the rotor 122 drives the wheel body 124 to rotate, the laser plate 14 will rotate along with it. When the light source 13 rotates relative to the laser plate 14, each respective pattern is rotated around its respective light-emitting point, so that the dynamic rotation effect of the plurality of preset patterns 141 is presented. Through this new type of application, the static pattern is converted into a rotating pattern, thereby achieving the rotating effect of the optical pattern at a low cost.

The light source 13 includes a circuit board 132 and a plurality of LED lamp beads 134 attached on the circuit board 132.

The plurality of LED lamp beads 134 may emit lights of different colors or different brightness. The circuit board 132 may have a circular shape, a square shape, a triangle shape, or the like.

The circuit board 132 can be connected to the motor shaft 112 and spaced from the stator 114 by an interval, such that the heat generated by the stator 114 is prevented from affecting the normal light output of the plurality of LED lamp beads 134.

In a further embodiment, the optical rotating wheel 10 further includes a heat insulation pad 15 whose opposite sides are respectively connected with the circuit board 132 and the stator 114. That is, the heat, insulation pad 15 is arranged between the circuit board 132 and the stator 114, such that the heat insulation pad 15 can support the circuit board 132 and at the same time prevent the heat generated by the stator 114 from being transmitted to the circuit board 132.

In a further embodiment, the optical rotating wheel 10 further includes a first cover 16 connected with the wheel body 124, the laser plate 14 is connected with a first side of the first cover 16 facing the light source 13, and a first area of the first cover 16 corresponding to the light source 13 is transparent or hollow out.

When the first area of the first cover 16 corresponding to the light source 13 is transparent, the first cover 16 protects the laser plate 14.

When the first area 161 of the first cover 16 corresponding to the light source 13 is hollow out, the rotating preset pattern 141 forms a three-dimensional special effect against the hollow out area of the first cover 16. Further, the laser plate 14 is detachably connected to the first cover 16, so that the user can replace the laser plate 14 according to his/her preference to change the type of the preset pattern 141.

In a preferable embodiment, the optical rotating wheel 10 further includes a first cover 16 and a second cover 17 successively connected with the wheel body 124. The laser plate 14 is arranged between the first cover 16 and the second cover 17. The first area 161 of the first cover 16 corresponding to the light source 13 is transparent or hollow out, and a first area 171 of the second cover 17 corresponding to the light source 13 is transparent or hollow out.

When the first area 171 of the second cover 17 corresponding to the light source 13 is transparent, the second cover 17 protects the laser plate 14.

When the first area of the second cover 17 corresponding to the light source 13 is hollow out, the rotating preset pattern 141 foul's a three-dimensional special effect against the hollow out area of the second cover 17. Further, the laser plate 14 is detachably connected to the second cover 17, so that the user can replace the laser plate 14 according to his/her preference to change the type of the preset pattern 141.

While the present application has been described with reference to certain embodiments, it will be understood by those skilled in the art that various changes may be made and equivalents may be substituted without departing from the scope of the present application. In addition, many modifications may be made to adapt a particular situation or material to the teachings of the present application without departing from its scope. Therefore, it is intended that the present application not be limited to the particular embodiment disclosed, but that the present application will include all embodiments falling within the scope of the appended claims.

What claimed is:

1. An optical rotating wheel including:
a stationary component, which includes a motor shaft fixedly connected with a vehicle body, and a stator fixedly connected with the motor shaft;
a moving component, which includes a rotor rotationally connected with the stator, and a wheel body fixedly connected with the rotor,
a light source connected with the stationary component; and
a laser plate connected with the moving component, wherein the laser plate is provided with a laser dot which displays a preset pattern under an illumination of the light source, and
wherein when the moving component rotates, the preset pattern rotates around the light source.

2. The optical rotating wheel according to claim 1, wherein the light source includes a plurality of light-emitting points surrounding the motor shaft, and the laser dot displays a plurality of preset patterns under the illumination of the plurality of light-emitting points; wherein when the moving component rotates, the plurality of preset patterns rotate respectively around their respective light-emitting points.

3. The optical rotating wheel according to claim 2, wherein the light source includes a circuit board and a plurality of LED lamp beads attached on the circuit board.

4. The optical rotating wheel according to claim 3, wherein the circuit board is connected to the motor shaft and is spaced from the stator by an interval.

5. The optical rotating wheel according to claim 1, wherein the optical rotating wheel further includes, a first cover connected with the wheel body, wherein the laser plate is connected with a first side of the first cover facing the light source, and a first area of the first cover corresponding to the light source is transparent or hollow out.

6. The optical rotating wheel according to claim 5, wherein the first area of the first cover corresponding to the light source is hollow out, wherein the laser plate and the first cover are detachably connected with each other.

7. The optical rotating wheel according to claim 1, wherein the optical rotating wheel further includes a first cover and a second cover successively connected with the wheel body, wherein the laser plate is arranged between the first cover and the second cover, wherein a first area of the first cover corresponding to the light source is transparent or hollow out, and a first area of the second cover corresponding to the light source is transparent or hollow out.

8. The optical rotating wheel according to claim 7, wherein the first area of the second cover corresponding to the light source is hollow out; the laser plate and the first cover, or the laser plate and the second cover are detachably connected with each other.

9. The optical rotating wheel according to claim 1, wherein the optical rotating wheel further includes a heat insulation pad whose opposite sides are respectively connected with the circuit board and the stator.

10. A self-balancing vehicle including a vehicle body and an optical rotating wheel for driving the vehicle body to move, wherein the optical rotating wheel further includes:
a stationary component, which includes a motor shaft fixedly connected with the vehicle body, and a stator fixedly connected with the motor shaft;
a moving component, which includes a rotor rotationally connected with the stator, and a wheel body fixedly connected with the rotor;
a light source connected with the stationary component; and
a laser plate connected with the moving component, wherein the laser plate is provided with a laser dot which displays a preset pattern under an illumination of the light source, and
wherein when the moving component rotates, the preset pattern rotates around the light source.

11. The self-balancing vehicle according to claim 10, wherein the light source includes a plurality of light-emitting points surrounding the motor shaft, and the laser dot displays a plurality of preset patterns under the illumination of the plurality of light-emitting points; wherein when the moving component rotates, the plurality of preset patterns rotate respectively around their respective light-emitting points.

12. The self-balancing vehicle according to claim 11, wherein the light source includes a circuit board and a plurality of LED lamp beads attached on the circuit board.

13. The self-balancing vehicle according to claim 12, wherein the circuit board is connected to the motor shaft and is spaced from the stator by an interval.

14. The self-balancing vehicle according to claim 10, wherein the optical rotating wheel further includes a first cover connected with the wheel body, wherein the laser plate is connected with a first side of the first cover facing the light source, and a first area of the first cover corresponding to the light source is transparent or hollow out.

15. The self-balancing vehicle according to claim 14, wherein the first area of the first cover corresponding to the light source is hollow out, and the laser plate and the first cover are detachably connected with each other.

16. The self-balancing vehicle according to claim 10, wherein the optical rotating wheel further includes, a first cover and a second cover successively connected with the wheel body, wherein the laser plate is arranged between the first cover and the second cover, wherein a first area of the first cover corresponding, to the light source is transparent or hollow out, and a first area of the second cover corresponding to the light source is transparent or hollow out.

17. The self-balancing vehicle according to claim 16, wherein the first area of the second cover corresponding to the light source is hollow out; the laser plate and the first cover, or the laser plate and the second cover are detachably connected with each other.

18. The self-balancing vehicle according to claim 10, wherein the optical rotating wheel further includes a heat insulation pad whose opposite sides are respectively connected with the circuit board and the stator.
